(19) United States
(12) Patent Application Publication
(10) Pub. No.: US 2017/0118751 A1
(43) Pub. Date: Apr. 27, 2017

(54) MANAGEMENT METHOD FOR WIRELESS NETWORK AND NETWORK MANAGEMENT NODE

(71) Applicant: INDUSTRIAL TECHNOLOGY RESEARCH INSTITUTE, Hsinchu (TW)

(72) Inventors: Ming-Che CHEN, Taichung City (TW); Yung-Ching HUANG, Taipei City (TW)

(73) Assignee: INDUSTRIAL TECHNOLOGY RESEARCH INSTITUTE, Hsinchu (TW)

(21) Appl. No.: 14/971,546

(22) Filed: Dec. 16, 2015

(30) Foreign Application Priority Data
Oct. 22, 2015 (TW) 104134651

(51) Int. Cl. H04W 72/04; H04W 24/10

(52) U.S. Cl. CPC H04W 72/0446; H04W 24/10

(57) ABSTRACT

A wireless network management method for a wireless network is provided. The wireless network management method includes: calculating a data transmission requirement of the wireless network; based on the calculated data transmission requirement, assigning at least an advertising timeslot in a slotframe; based on the calculated data transmission requirement, determining whether to assign and how to assign at least a data timeslot in the slotframe; and advertising a timeslot assignment of the slotframe.

### CROSS-REFERENCE TO RELATED ART

This application claims the benefit of Taiwan application Serial No. 104134651, filed Oct. 22, 2015, the disclosure of which is incorporated by reference herein in its entirety.

### TECHNICAL FIELD

The disclosure relates in general to a wireless network management method and a network management node.

### BACKGROUND

Wireless sensing network system adopts time slotted channel hopping (TSCH) technology for transmitting packets in low power consumption and high reliability. In the wireless sensing networks adopting time slotted channel hopping technology, timeslot assignment in a slotframe is periodically advertised by a network management node and managed nodes and new nodes may be dynamically joined the wireless sensing network. Besides, the network management node assigns timeslots during which the managed nodes transmit data packets.

Therefore, it has become a task to provide a wireless network management method and a network management node which improve the efficiency of the wireless network.

### SUMMARY

The disclosure is directed to a wireless network management method and a network management node. After the data transmission requirement is calculated, the quantity of advertising timeslots that is to be assigned in the slotframe is obtained, such that the network management node and/or the managed nodes joining the wireless network may advertise in the advertising timeslots.

According to one embodiment, a wireless network management method for a wireless network is provided. A data transmission requirement of the wireless network is calculated. At least one advertising timeslot is assigned in a slotframe based on the calculated data transmission requirement. Whether to assign and how to assign at least one data timeslot in the slotframe is determined based on the calculated data transmission requirement. A timeslot assignment of the slotframe is advertised.

According to another embodiment, a network management node for a wireless network is provided. The network management node includes a data timeslot requirement calculation sub-module, an advertising timeslot assignment sub-module and a data timeslot assignment sub-module. The data timeslot requirement calculation sub-module calculates a data transmission requirement of the wireless network. The advertising timeslot assignment sub-module assigns at least one advertising timeslot in a slotframe based on the calculated data transmission requirement. The data timeslot assignment sub-module determines whether to assign and how to assign at least one data timeslot in the slotframe based on the calculated data transmission requirement, and advertises a timeslot assignment of the slotframe.

The above and other contents of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a functional diagram of a network management node of a wireless network according to an embodiment of the present disclosure.

FIG. 2 shows a flowchart of a wireless network management method according to an embodiment of the present disclosure.

FIG. 3A shows an example of the wireless network.

FIGS. 3B˜3D show schematic diagrams of assigning advertising timeslots in a slotframe based on a node join sequence (without considering the data transmission requirement) according to an embodiment of the present disclosure.

FIG. 4A˜4C shows schematic diagrams of assigning advertising timeslots in a slotframe based on a node join sequence (with considering the data transmission requirement) according to an embodiment of the present disclosure.

FIG. 5 shows a schematic diagram of assigning advertising timeslots in a slotframe based on a node join sequence and a cross-slotframe assignment according to an embodiment of the present disclosure

FIG. 6 shows an example of a wireless network showing node level.

FIG. 7A shows a schematic diagram of assigning advertising timeslots in a slotframe in a wireless network based on node level without considering the data transmission requirement according to an embodiment of the present disclosure.

FIG. 7B shows a schematic diagram of assigning advertising timeslots in a slotframe in a wireless network based on node level with considering the data transmission requirement according to an embodiment of the present disclosure.

FIG. 7C shows a schematic diagram of assigning advertising timeslots in the wireless network based on node level and a cross-slotframe assignment according to an embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DESCRIPTION OF THE EMBODIMENTS

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

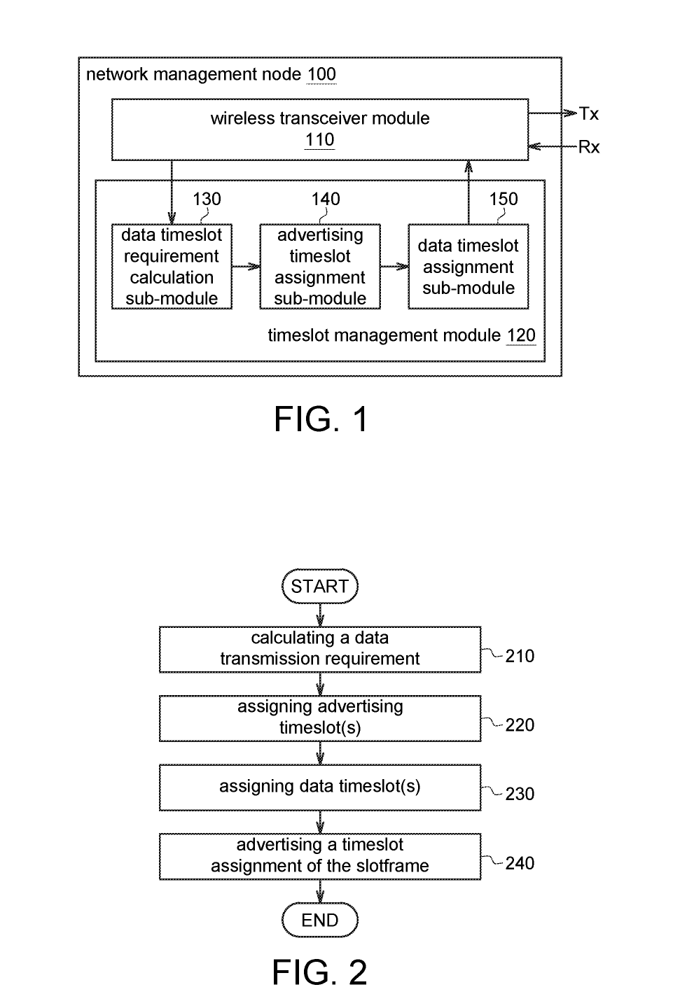

Referring to FIG. 1, a functional diagram of a network management node of a wireless network 100 according to an embodiment of the present disclosure is shown. The network management node 100 includes: a wireless transceiver module 110 and a timeslot management module 120. In an embodiment of the present disclosure, the wireless network, exemplarily but not restrictively, may be realized by a centralized time slotted channel hopping (TSCH) wireless network.

The wireless transceiver module 110 is for receiving and transmitting wireless signals. The wireless transceiver module 110 may receive wireless signals from an external source (such as a managed node) and further transmit the wireless signals. The wireless transceiver module 110 may be implemented by hardware.

The timeslot management module 120 is for managing and determining the assignment of timeslots. The timeslot management module 120 includes a data timeslot requirement calculation sub-module 130, an advertising timeslot assignment sub-module 140 and a data timeslot assignment sub-module 150. The timeslot management module 120 and the sub-modules 130-150 may be implemented by hardware and/or software.

The data timeslot requirement calculation sub-module 130 calculates a data transmission requirement of the wireless network. That is, the data timeslot requirement calculation sub-module 130 calculates the required quantity of data timeslots based on total data transmission requirements of all managed nodes having joined the wireless network.

The advertising timeslot assignment sub-module 140, based on the calculated data transmission requirement, assigns at least one advertising timeslot in a slotframe. That is, the advertising timeslot assignment sub-module 140 subtracts the required quantity of data timeslots from the total quantity of timeslots in the slotframe to obtain the quantity of remaining timeslots. Then, the advertising timeslot assignment sub-module 140 classifies the remaining timeslots as the advertising timeslots and the receiving timeslots, and assigns the advertising timeslots and the receiving timeslots to the network management node and the managed nodes having joined the wireless network for advertising and receiving.

The data timeslot assignment sub-module 150, based on the calculated data transmission requirement, determines whether to assign and how to assign at least one data timeslot in the slotframe, and then advertises a timeslot assignment. That is, the data timeslot assignment sub-module 150 assigns data timeslots for the managed nodes having joined the wireless network to transmit data.

Referring to FIG. 2, a flowchart of a wireless network management method according to an embodiment of the present disclosure is shown. As indicated in step 210 of FIG. 2, a data transmission requirement (that is, a data timeslot requirement) is calculated. Step 210 may be performed by the data timeslot requirement calculation sub-module 130 which calculates a data transmission requirement of the wireless network to determine how many data timeslots are assigned in the slotframe. In step 220, the advertising timeslots are assigned. Step 220 may be performed by the advertising timeslot assignment sub-module 140. In step 230, the data timeslots are assigned. In step 240, a timeslot assignment of the slotframe is announced. The timeslot assignment refers to which timeslots in a slotframe are assigned as the advertising timeslots and which timeslots in the slotframe are assigned as the data timeslots. Steps 230 and 240 may be performed by such as the data timeslot assignment sub-module 150.

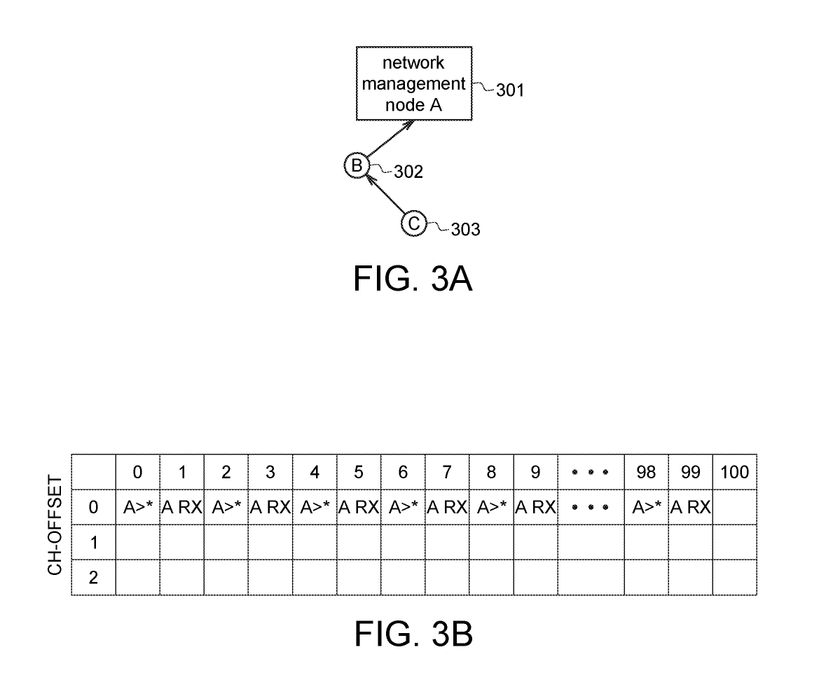

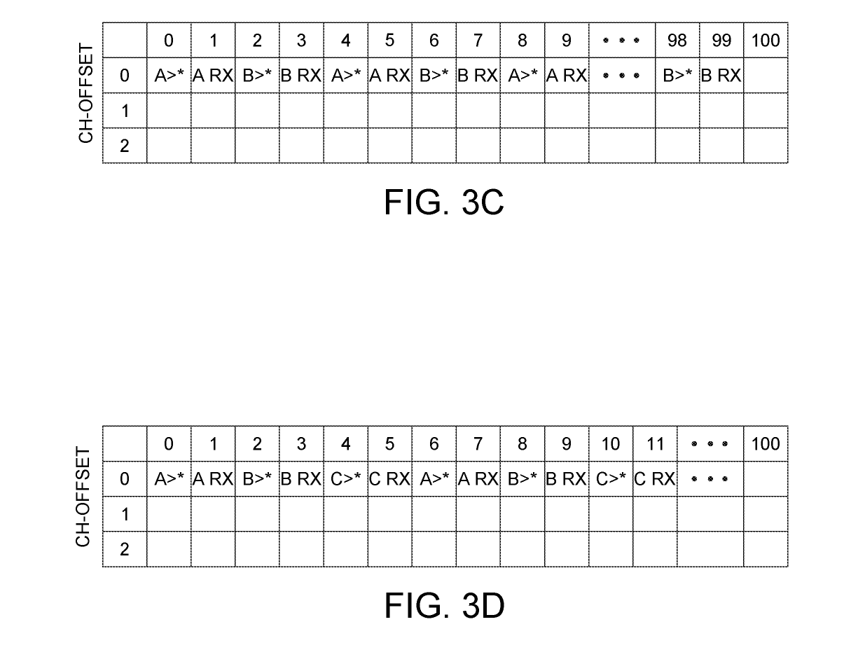

Detailed descriptions of assigning timeslots and joining new nodes into the wireless network are disclosed in an embodiment of the present disclosure with reference to accompanying drawings. FIG. 3A shows an example of a wireless network. The wireless network may include a network management node (A) 301, and managed nodes (B) 302 and (C) 303. The structure of the network management node (A) 301 is illustrated in FIG. 1. The managed nodes (B) 302 and (C) 303, which may be realized by wireless network nodes such as wireless sensors, receive an advertising message from the network management node (A) 301 or other managed nodes to join the wireless network.

In the descriptions disclosed below, the slotframe includes a plurality of timeslots such as timeslots 0˜100. Here, the quantity of timeslots of the slotframe is for exemplary purpose only, not for limiting the present disclosure.

FIGS. 3B˜3D show schematic diagrams of assigning advertising timeslots to a slotframe based on a node join sequence (without considering the data transmission requirement) according to an embodiment of the present disclosure.

FIG. 3B shows a schematic diagram of assigning advertising timeslots in a slotframe in the wireless network (including the network management node (A) 301 but no any managed nodes) based on a node join sequence without considering the data transmission requirement according to an embodiment of the present disclosure. That is, FIG. 3B shows the initial state of the wireless network wherein none of the managed nodes has joined to wireless network. As indicated in FIG. 3B, the network management node (A) 301 assigns a plurality of advertising timeslots (A>*) and a plurality of receiving timeslots (A RX) in a slotframe without considering the data timeslot requirement (that is, without considering the data transmission requirement of the managed nodes). As indicated in FIG. 3B, the network management node (A) 301 fills the slotframe with as many advertising timeslots (A>*) and receiving timeslots (A RX) as possible to achieve excellent advertising effect. As indicated in FIG. 3B, one timeslot (timeslot 100) is left at the end of the slotframe. The timeslot 100 is left blank because it is not enough to assign the advertising timeslot (A>*) and the receiving timeslot (A RX) concurrently in one timeslot. It needs two timeslots to assign the advertising timeslot (A>*) and the receiving timeslot (A RX).

In the advertising timeslot, if a node receives an advertising message from the network management node (A) 301, then the node will transmit a join request in the next timeslot (that is, in a receiving timeslot) together with a data transmission requirement (for example, to inform that one or two data will be transmitted back within a slotframe).

In the receiving timeslots (A RX), the network management node (A) 301 will “listen” to check whether there are any nodes sending a request for joining the wireless network (a join request). If the network management node (A) 301 receives a join request and a data transmission requirement from a node, the network management node (A) 301 will add the node to the wireless network and change the timeslot assignment to assign the advertising timeslots and the receiving timeslots for the newly-joined managed node. The advertising timeslots and the receiving timeslots basically are paired with each other. That is, if an advertising timeslot is assigned to the network management node or the managed node, a corresponding receiving timeslot needs to be assigned to the same network management node or managed node. The paired advertising timeslot and receiving timeslot are not sent in the same channel. Detailed descriptions for assigning the channel for sending the advertising timeslots and the receiving timeslots are disclosed below.

In an embodiment of the present disclosure, the nodes requesting to join the wireless network (such as the managed nodes (B) 302 and (C) 303) will receive an advertising message from the network management node (A) 301 in a fixed channel. After the node requesting to join the wireless network (such as the managed nodes (B) 302 and (C) 303) receive the advertising message from the network management node (A) 301 in the fixed channel, the nodes receiving the advertising message may perform time synchronization to obtain the timeslot number of the next timeslot (i.e. the next receiving timeslot). The advertising message includes a timeslot assignment relevant information, a time synchronization information and a channel-hopping table. Based on the channel-hopping table and the channel hopping formula disclosed below, the node requesting to join the wireless network may calculate the channel which is used to send the receiving timeslot. The node requesting to join the wireless network may transmit the request for joining the network within the receiving timeslot through the channel. The network management node (A) 301, based on the channel-hopping table and channel hopping formula disclosed below, may calculate the channel which is used to send the receiving timeslot, and further listen through the channel to check whether any request for joining the network are received.

The channel hopping principles of the embodiments of the present disclosure are disclosed below.

Referring to Table 1, a channel-hopping table is illustrated.

TABLE 1

| Index | Selected Channel |
|---|---|
| 0 | Ch 5 |
| 1 | Ch 0 |
| 2 | Ch 3 |
| 3 | Ch 11 |
| 4 | Ch 15 |
| 5 | Ch 10 |
| 6 | Ch 6 |
| 7 | Ch 9 |
| 8 | Ch 7 |
| 9 | Ch 12 |
| 10 | Ch 4 |
| 11 | Ch 8 |
| 12 | Ch 2 |
| 13 | Ch 13 |
| 14 | Ch 14 |
| 15 | Ch 1 |

The index parameter “Index” may be expressed as:

Index=(ASN+offset) % Nc

Wherein “ASN” represents a timeslot number; “offset” represents a channel offset (CH-OFFSET); “Nc” represents a total quantity of the channels used in the wireless network; mathematic operator “%” represents a residue operator. After the index parameter “Index” is obtained, the selected channel may be found from Table 1.

Let FIG. 3B be taken for example. When the network management node (A) 301 advertises in the 1^{st} advertising timeslot A>* (the timeslot 0 which corresponds to the channel offset 0), the index parameter is Index=(0+0)%16=0%16=0. “Index” 0 means that the channel Ch 5 is selected. That is, in timeslot 0, the network management node (A) 301 advertises the 1^{st} advertising timeslot A>* (the timeslot 0) through the channel Ch 5. In timeslot 1, the network management node (A) 301 listens through the channel Ch 0 to check whether there are any responses from the nodes. Similarly, in timeslot 2, the network management node (A) 301 switches to channel Ch 3 to advertise. When in timeslot 3, the network management node (A) 301 listens through the channel Ch 11 to check whether there are any responses from the nodes.

The advertising message includes: a timeslot assignment relevant information, a time synchronization information and a channel-hopping table. Through the time synchronization information, the managed node is time synchronized with the network management node.

After the managed node receives the advertising message, the managed node may perform time synchronization with the network management node. Additionally, the node requesting to join the wireless network will send a join request in the same manner disclosed above. As disclosed above, if a network management node or a relay managed node receives the join request during the receiving timeslot, the network management node will add the node to the wireless network. Whenever a new node joins the wireless network, the network management node will update and advertise the timeslot assignment.

If there are two or more than two nodes requesting to join the wireless network, it is possible that these nodes may receive advertising messages in the same advertising timeslot and send back the join request through the same channel in the same next timeslot (i.e. the same receiving timeslot), hence causing response collision. The node requesting to join the wireless network may use Carrier Sense Multiple Access with Collision Avoidance (CSMA/CA) to monitor whether the desired channel is occupied and then decide whether to send data back by the desired channel. If the node requesting to join the wireless network confirms that the selected channel is already occupied by other nodes, then the node requesting to join the wireless network may wait for a randomly time interval (i.e. wait for a random number of timeslots) and then again listen to the advertising message through the fixed channel.

Refer to FIG. 3B. In an embodiment of the present disclosure, a network management node and/or a relay managed node sends the advertising message in the advertising timeslots in a slotframe by channel hopping. That is, the network management node and/or the relay managed node may send the advertising message in the advertising timeslots through different channels and the chance that the nodes receive the advertising timeslots is higher. In an embodiment of the present disclosure, the waiting time for which a node to join the wireless network may be shortened and thus power consumption of the node is also lowered. Since the network management node may try all its best to fill up the slotframe with the advertising timeslots, the efficiency of using the slotframe may be increased.

Refer to FIG. 3B. In average, the 1^{st} node waits for 16 timeslots before it joins the wireless network. To the best scenario, the 1^{st} node waits for 2 timeslots before it joins the wireless network. If the channel used by the node is the same as the channel through which the network management node advertises the 1st advertising message, the node may receive the advertising message in timeslot 0 and send the join request in timeslot 1. To the worse scenario, the 1st node waits for 32 timeslots before it joins the wireless network. That is because, if the channel used by the node is the same as the channel through which the network management node advertises the 16-th advertising message, the node does not receive the advertising message until timeslot 30. Then, the node sends the join request in timeslot 31.

Referring to FIG. 3C, a schematic diagram of assigning advertising timeslots in a slotframe in the wireless network (including the network management node (A) 301 and the managed node (B) 302) based on a node join sequence without considering the data transmission requirement according to an embodiment of the present disclosure is shown. When assigning advertising timeslots, the network management node (A) 301 cyclically assigns the advertising timeslots for the network management node (A) 301 and the managed node (B) 302 according to the node join sequence. As indicated in FIG. 3C, the network management node (A) 301 assigns the timeslots 0 and 1 as the advertising timeslot (A>*) and the receiving timeslot (A RX) for the network management node (A) 301. Since the managed node (B) 302 is the 1^{st} managed node to join the wireless network, the network management node (A) 301 assigns timeslots 2 and 3 as the advertising timeslot (B>*) and the receiving timeslot (B RX) for the managed node (B) 302, and so on. After the network management node (A) 301 completes the timeslot assignment, the network management node (A) 301 advertises the timeslot assignment (through the advertising message). Therefore, after receiving the advertising message from the network management node (A) 301, the managed node (B) 302 advertises in the timeslot 2 and receives in the timeslot 3, and so on.

In an embodiment of the present disclosure, the managed nodes already joining the wireless network may help the network management node to send advertising messages, for increasing the efficiency of joining the node into the wireless network.

Refer to FIG. 3C. In average, the 2^{nd} node waits for 32 timeslots before it joins the wireless network. After the 2^{nd} node joins the wireless network, the network management node updates and advertises a new timeslot assignment, so that all managed nodes having been joined to the wireless network may obtain and follow the updated timeslot assignment.

Referring to FIG. 3D, a schematic diagram of assigning advertising timeslots in a slotframe in the wireless network (including the network management node (A) 301, and the managed nodes (B) 302 and (C) 303) based on a node join sequence without considering the data transmission requirement. The managed node (C) 303 is the 2^{nd} managed node to join the wireless network. Let FIG. 3A be taken for example. The managed node (C) 303 does not directly send data back to the network management node (A) 301. Instead, data from the managed node (C) 303 is sent through the managed node (B) 302. Therefore, the managed node (B) 302 may be referred as a “relay managed node”.

When assigning advertising timeslots, the network management node (A) 301 cyclically assigns the advertising timeslots for the network management node (A) 301 and the managed node according to the node join sequence. As indicated in FIG. 3D, the network management node (A) 301 assigns the timeslots 0 and 1 as the advertising timeslot (A>*) and the receiving timeslot (A RX) for the network management node (A) 301. The network management node (A) 301 assigns the timeslots 2 and 3 as the advertising timeslot (B>*) and the receiving timeslot (B RX) for the managed node (B) 302. The network management node (A) 301 assigns the timeslot 4 and the timeslot 5 as the advertising timeslot (C>*) and the receiving timeslot (C RX) for the managed node (C) 303, and so on.

If the wireless network includes more managed nodes, timeslots may be assigned in a slotframe according to the above assignment, and the details are omitted here.

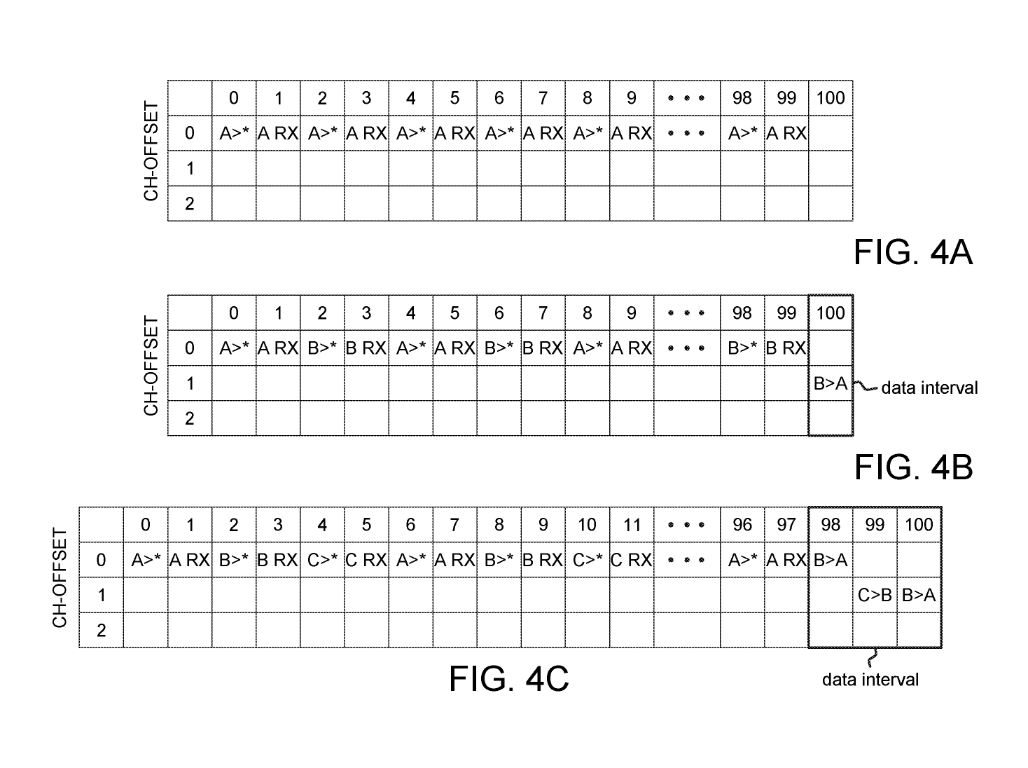

In another embodiment of the present disclosure, how to assign timeslots in a slotframe based on a data transmission requirement is disclosed. FIGS. 4A˜4C are schematic diagrams of assigning advertising timeslots in a slotframe based on a node join sequence and a data transmission requirement according to an embodiment of the present disclosure.

FIG. 4A shows a schematic diagram of assigning advertising timeslots in a slotframe in the wireless network (including the network management node (A) 301 but no any managed nodes) based on a node join sequence and a data transmission requirement according to an embodiment of the present disclosure. That is, FIG. 4A shows the initial state of the wireless network which does not include any managed nodes. Although the data transmission requirement is considered, there is no data transmission requirement because the wireless network does not include any managed nodes. The timeslot assignment of FIG. 4A is the same as that in FIG. 3B, and the details are omitted here.

Referring to FIG. 4B, a schematic diagram of assigning advertising timeslots in a slotframe in the wireless network (including the network management node (A) 301 and the managed node (B) 302) based on a node join sequence and a data transmission requirement according to an embodiment of the present disclosure is shown. It is assumed that in the slotframe, the managed node (B) 302 generates one data (occupying one timeslot) and sends to the network management node (A) 301. Therefore, after the data transmission requirement of the managed node (B) 302 is obtained (requiring one timeslot for transmitting data), the network management node (A) 301 may obtain that there are still 100 remaining timeslots ((101−1)=100) which may be assigned as the advertising timeslots and the receiving timeslots in the slotframe. Therefore, the network management node (A) 301, based on the node join sequence, cyclically assigns the 100 timeslots as the advertising timeslots and the receiving timeslots for the network management node (A) 301 and the managed node (B) 302, respectively. Details of the assignment of the advertising interval are indicated in FIG. 3C. Then, the network management node (A) 301 assigns the data timeslot required by the managed node (B) 302 at the end of the slotframe. The network management node (A) 301 assigns the timeslot 100 to the managed node (B) 302 for transmitting data.

As indicated in FIG. 4B, the timeslots 0˜99 are referred as the advertising interval, and the timeslot 100 is referred as the data interval. The data interval is arranged after the advertising interval. However, the present disclosure is not limited thereto, and the data interval may be arranged before or between the advertising interval.

After receiving the advertising message from the managed node (B) 302, the node (C) 303 sends a join request to the managed node (B) 302. After receiving the join request from the node (C) 303, in transmitting data to the network management node (A) 301 (that is, during the timeslot 100), the managed node (B) 302 may inform the network management node (A) 301 that the node (C) 303 requests to join the wireless network. Thus, the network management node (A) 301 may join the node (C) 303 to the wireless network.

In the above embodiment, if the data transmission requirement changes (for example, it needs more or fewer timeslots for data transmission), the network management node (A) 301 may update and advertise the timeslot assignment.

Referring to FIG. 4C, a schematic diagram of assigning advertising timeslots in a slotframe in a wireless network (including the network management node (A) 301 and the managed nodes (B) 302 and (C) 303) based on a node join sequence and a data transmission requirement according to an embodiment of the present disclosure. It is assumed that in the slotframe, the managed nodes (B) 302 and (C) 303 respectively generate one data (occupying one timeslot) for sending data back to the network management node (A) 301. As indicated in FIG. 3A, the managed node (C) 303 sends data back to the network management node (A) 301 through the managed node (B) 302. That is, the managed node (B) 302 transmits its own data and data from the managed node (C) 303 back to the network management node (A) 301, respectively.

Therefore, after obtaining total data transmission requirements of the managed nodes (B) 302 and (C) 303 (in total, 3 timeslots are required for transmitting data), the network management node (A) 301 obtains that there are still 98 (101−3=98) available timeslots which may be assigned as the advertising timeslots and the receiving timeslots in the slotframe. Therefore, the network management node (A) 301 cyclically assigns the 98 timeslots as advertising intervals for the network management node (A) 301 and the managed nodes (B) 302 and (C) 303, respectively, based on the node join sequence. Details of assigning the advertising interval are indicated in FIG. 4C.

That is, in FIG. 4C, the timeslots 0˜97 are assigned as the advertising interval, and the timeslots 98˜100 are assigned as the data interval. In the timeslot 98, the managed node (B) 302 transmits its data back to the network management node (A) 301. In the timeslot 99, the managed node (C) 303 transmits its data back to the managed node (B) 302. In timeslot 100, the managed node (B) 302 transmits data from the managed node (C) 303 back to the network management node (A) 301.

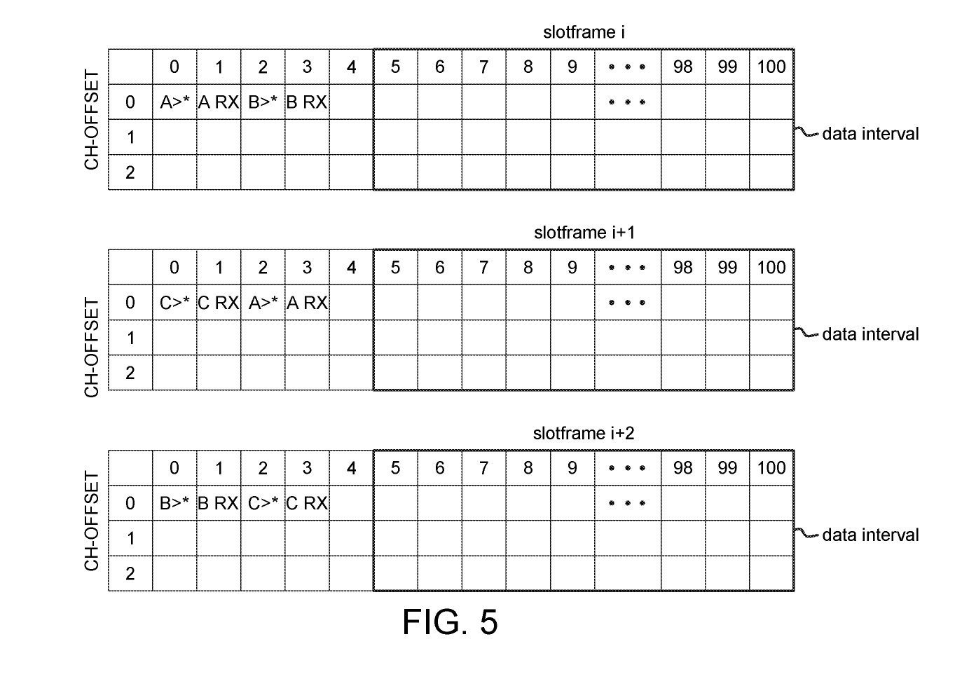

If the data transmission requirement is too high, the quantity of remaining timeslots in a slotframe may not be enough to satisfy the data transmission requirement for all nodes. In another embodiment of the present disclosure, the problem may be resolved by the cross-timeslot assignment. FIG. 5 shows a schematic diagram of assigning advertising timeslots in a slotframe based on a node join sequence and a cross-timeslot assignment according to an embodiment of the present disclosure.

Suppose the wireless network currently includes the network management node (A) 301, and the managed nodes (B) 302 and (C) 303.

As indicated in FIG. 5, after obtaining the data transmission requirement for the managed nodes, if the network management node (A) 301 determines that in the slotframe, 96 timeslots are assigned as the data interval, then there are 5 available timeslots which may be used as the advertising interval. However, it needs at least 6 timeslots to be assigned as the advertising intervals. The network management node (A) 301 assigns the timeslots at the beginning of the slotframes i˜i+2 as the advertising timeslots, wherein “i” is a positive integer. To put it in greater details, timeslots 0 and 1 of the slotframe i and timeslots 2 and 3 of the slotframe i+1 are assigned as the advertising timeslots (A>*) and the receiving timeslots (A RX) for the network management node (A) 301. Timeslots 2 and 3 of the slotframe i and timeslots 0 and 1 of the slotframe i+2 are assigned as the advertising timeslots (B>*) and the receiving timeslots (B RX) for the managed node (B) 302. Timeslots 0 and 1 of the slotframe i+1 and timeslots 2 and 3 of the slotframe i+2 are assigned as the advertising timeslots (C>*) and the receiving timeslots (C RX) for the managed node (C) 303.

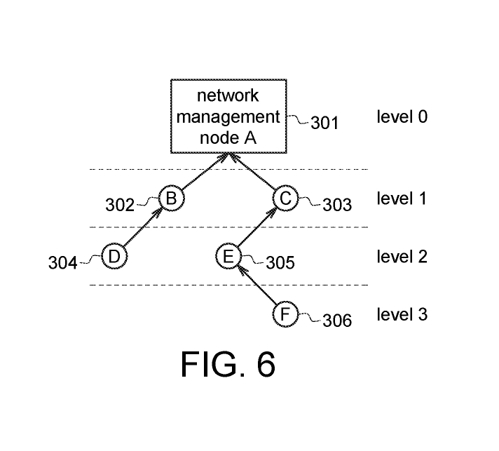

In another embodiment of the present disclosure, the sequence of assigning the advertising timeslots for the managed nodes is based on node level. FIG. 6 shows an example of the wireless network showing node level. As indicated in FIG. 6, the wireless network includes the network management node (A) 301 and the managed nodes (B) 302-(F) 306. The network management node (A) 301 is at level 0 (Lv 0), the managed nodes (B) 302 and (C) 303 are at level 1 (Lv 1), and so on. When assigning the advertising timeslots, the network management node (A) 301 cyclically assigns the advertising timeslots based on the node level. The managed nodes at the same level are assigned and advertised in the same timeslot but have different channel offsets. The managed nodes at the same node level may advertise or receive in the same timeslot through different channels.

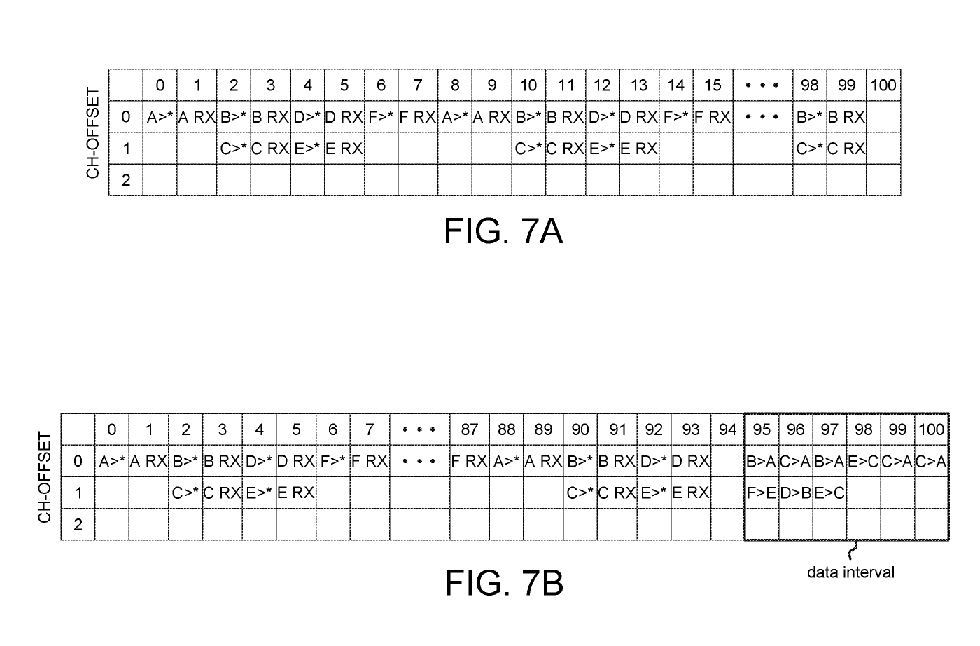

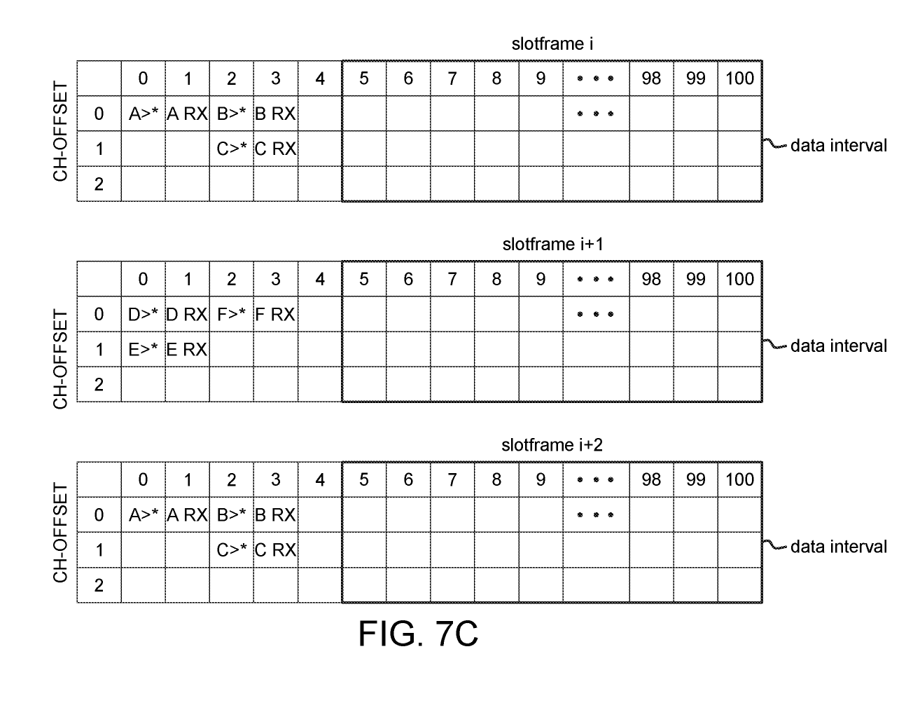

FIG. 7A shows a schematic diagram of assigning advertising timeslots in a slotframe in the wireless network based on node level without considering the data transmission requirement according to an embodiment of the present disclosure. As indicated in FIG. 7A, the network management node (A) 301 assigns timeslots 0 and 1 as the advertising timeslot (A>*) and the receiving timeslot (A RX) for the network management node (A) 301. Since the managed nodes (B) 302 and (C) 303 are at level 1, the network management node (A) 301 assigns timeslots 2 and 3 as the advertising timeslots (B>* and C>*) and the receiving timeslots (B RX and C RX) for the managed nodes (B) 302 and (C) 303. The managed node (B) 302 advertises through the channel Ch 3 (with channel offset of 0) and receives through the channel Ch 11. The managed node (C) 303 advertises through the channel Ch 11 (with channel offset of 1) and receives through the channel Ch 15, and so on.

FIG. 7B shows a schematic diagram of assigning the advertising timeslots in a slotframe in the wireless network based on node level and the data transmission requirement according to an embodiment of the present disclosure. As indicated in FIG. 7B, after considering the data transmission requirement, the network management node (A) 301 determines that in the slotframe, 6 timeslots are assigned as the data interval, therefore there are 95 (101−6=95) available timeslots which may be assigned as the advertising interval in the slotframe. The network management node (A) 301 assigns the advertising interval according to the same principle illustrated in FIG. 7A. However, after assignment, one timeslot (timeslot 94) is left available which is not enough to assign the advertising timeslot (F>*) and the receiving timeslot (F RX) for the managed node (F) 306. Thus, the timeslot 94 is left blank.

FIG. 7C shows a schematic diagram of assigning advertising timeslots in the wireless network (including the network management node (A) 301 and the managed nodes (B) 302-(F) 306) based on node level and a cross-timeslot assignment according to an embodiment of the present disclosure. Like FIG. 5, if the data transmission requirement is high, the quantity of remaining timeslots in the slotframe is not enough to assign the required advertising timeslots.

As indicated in FIG. 7C, after obtaining the data transmission requirement of the managed nodes, the network management node (A) 301 determines that the slotframe requires 96 timeslots as the data interval, therefore the slotframe has 5 timeslots left to be assigned as the advertising interval. However, it needs at least 8 timeslots as the advertising intervals. The network management node (A) 301 uses the timeslots at the beginning of the slotframes i−i+2 as the advertising intervals, wherein “i” is a positive integer. To put it in greater details, timeslots 0 and 1 of the slotframe i and timeslots 0 and 1 of the slotframe i+2 are assigned as the advertising timeslot (A>*) and the receiving timeslot (A RX) for the network management node (A) 301. The timeslots 2 and 3 of the slotframe i and the timeslots 2 and 3 of the slotframe i+2 are assigned as the advertising timeslots (B>* and C>*) and the receiving timeslots (B RX and C RX) for the managed nodes (B) 302 and (C) 303. Timeslots 0 and 1 of the slotframe i+1 are assigned as the advertising timeslots (D>* and E>*) and the receiving timeslots (D RX and E RX) for the managed node (D) 304 and the managed node (E) 305. Timeslot 2 and 3 of the slotframe i+1 are assigned as the advertising timeslot (F>*) and the receiving timeslot (F RX) for the managed node (F) 306, and so on.

As indicated in FIGS. 7A˜7C, the node join sequence may also be considered. If the managed node (B) 302 joins the wireless network earlier than the managed node (C) 303, then the managed node (B) 302 may be assigned to channel offset 0, and the managed node (C) 303 may be assigned to channel offset 1. That is, the assignment of channel offsets based on join sequence is also within the spirit of the present disclosure.

In the above embodiments of the present disclosure, the network management node may update and advertise the timeslot assignment according to the above principles if a new node joins the wireless network, if any one of the existing managed nodes is withdrawn from the wireless network or if the data transmission requirement changes. Or, after a period of time, the network management node, based on the current network status, may determine whether to update the timeslot assignment. In an embodiment of the present disclosure, the withdrawal of the existing managed node from the wireless network refers to the situation that the node sends a “network withdraw request” to the network management node in the data timeslot, or the situation that the network management node finds out that after a period of time, the node does not transmit data according to the assigned data timeslot. If any of the above situations happens, the network management node may withdraw the existing managed node from the wireless network. After withdrawing the node, the network management node may update and advertise the timeslot assignment according to the above principles.

In the above embodiments, the advertising intervals are arranged before the data intervals, but the present disclosure is not limited thereto. In other possible embodiments of the present disclosure, the advertising intervals may also be arranged after the data intervals.

In the above embodiment of the present disclosure, as many advertising timeslots as possible are assigned in the slotframe, and the node waits for a short time interval to be joined into the wireless network, which is helpful for reducing the power consumption of the node and joining the nodes into the wireless network. Since more advertising intervals are assigned to the slotframe, the waste of timeslots may be reduced and the slotframe may be used more efficiently.

It will be apparent to those skilled in the art that various modifications and variations may be made to the disclosed embodiments. It is intended that the specification and examples be considered as exemplary only, with a true scope of the disclosure being indicated by the following claims and their equivalents.

What is claimed is:

1. A wireless network management method for a wireless network, comprising:
calculating a data transmission requirement of the wireless network;
assigning at least one advertising timeslot in a slotframe based on the calculated data transmission requirement;
determining whether to assign and how to assign at least one data timeslot in the slotframe based on the calculated data transmission requirement; and
advertising a timeslot assignment of the slotframe.

2. The wireless network management method according to claim 1, wherein the step of calculating the data transmission requirement comprises:
determining that how many data timeslots are to be arranged in the slotframe.

3. The wireless network management method according to claim 1, further comprising:
assigning at least one receiving timeslot corresponding to the at least one advertising timeslot in the slotframe.

4. The wireless network management method according to claim 3, wherein
an advertising message is advertised in the wireless network within the advertising timeslot;
the wireless network listens to check whether a join request is received within the receiving timeslot; and
if the join request is received, then a managed node sending the join request is newly joined to the wireless network, the timeslot assignment is changed, and at least one advertising timeslot and at least one receiving timeslot are assigned to the newly-joined managed node.

5. The wireless network management method according to claim 4, wherein
the advertising message comprises: a timeslot assignment relevant information, a time synchronization information and a channel-hopping table.

6. The wireless network management method according to claim 1, wherein
a plurality of advertising timeslots and a plurality of receiving timeslots are assigned to substantially fill up the slotframe based on a node join sequence and/or a node level without considering the data transmission requirement, and the advertising timeslots and the receiving timeslots are sent by channel hopping.

7. The wireless network management method according to claim 1, wherein
a plurality of advertising timeslots, a plurality of receiving timeslots and the at least one data timeslot are assigned to substantially fill up the slotframe based on a node join sequence and/or a node level with considering the data transmission requirement, and the advertising timeslots and the receiving timeslots are sent by channel hopping.

8. The wireless network management method according to claim 7, wherein
based on the data transmission requirement, if the quantity of remaining timeslots does not satisfy the required quantity of advertising timeslots within the single slotframe, then the to-be-assigned advertising timeslots and the to-be-assigned receiving timeslots are assigned to be across a plurality of slotframes.

9. The wireless network management method according to claim 1, wherein
the timeslot assignment is updated and advertised if the data transmission requirement changes, if a new managed node joins the wireless network, or if any one of an existing managed nodes is withdrawn from the wireless network.

10. A network management node for a wireless network, comprising:
a data timeslot requirement calculation sub-module for calculating a data transmission requirement of the wireless network;
an advertising timeslot assignment sub-module for assigning at least one advertising timeslot in a slotframe based on the calculated data transmission requirement; and
a data timeslot assignment sub-module for determining whether to assign and how to assign at least one data timeslot in the slotframe based on the calculated data transmission requirement and advertising a timeslot assignment of the slotframe.

11. The network management node according to claim 10, wherein the data timeslot requirement calculation sub-module determines that how many data timeslots are to be arranged in the slotframe.

12. The network management node according to claim 10, wherein
the advertising timeslot assignment sub-module assigns at least one receiving timeslot corresponding to the at least one advertising timeslot in the slotframe.

13. The network management node according to claim 12, wherein
the network management node advertises an advertising message in the wireless network within the advertising timeslot;
the network management node listens to check whether a join request is received within the receiving timeslot; and
if the join request is received, then a managed node sending the join request is newly joined to the wireless network, the timeslot assignment is changed, and at least one advertising timeslot and at least one receiving timeslot are assigned to the newly-joined managed node.

14. The network management node according to claim 13, wherein
the advertising message comprises: a timeslot assignment relevant information, a time synchronization information and a channel-hopping table.

15. The network management node according to claim 10, wherein
the advertising timeslot assignment sub-module assigns a plurality of advertising timeslots and a plurality of receiving timeslot to substantially fill up the slotframe based on a node join sequence and/or a node level in the slotframe without considering the data transmission requirement, and the advertising timeslots and the receiving timeslots are sent by channel hopping.

16. The network management node according to claim 10, wherein
based on a node join sequence and/or a node level, the advertising timeslot assignment sub-module and the data timeslot assignment sub-module assign a plurality of advertising timeslots, a plurality of receiving timeslots and the at least one data timeslot in the slotframe to substantially fill up the slotframe with considering the data transmission requirement, and the advertising timeslots and the receiving timeslots are sent by channel hopping.

17. The network management node according to claim 16, wherein
based on the data transmission requirement, if the quantity of remaining timeslots does not satisfy the required quantity of advertising timeslots within the single slotframe, then the advertising timeslot assignment sub-module assigns the to-be-assigned advertising timeslots and the to-be-assigned receiving timeslots to cross a plurality of slotframes.

18. The network management node according to claim 10, wherein the network management node updates and advertises the timeslot assignment if the data transmission requirement changes, if a new managed node joins the wireless network, or if any one of an existing managed nodes is withdrawn from the wireless network.
